(19) United States
(12) Patent Application Publication
(10) Pub. No.: US 2009/0125594 A1
(43) Pub. Date: May 14, 2009

(54) Instant Messaging Intercom System

(75) Inventor: Jeffrey G. Gartner, Hopewell Junction, NY (US)

Correspondence Address: Avaya;DEMONT & BREYER, LLC, 100 COMMONS WAY, STE 250, HOLMDEL, NJ, 07733, US

(73) Assignee: AVAYA TECHNOLOGY LLC, Basking Ridge, NJ (US)

(21) Appl. No.: 11/939,258

(22) Filed: Nov. 13, 2007

(51) Int. Cl. G06F 15/16

(52) U.S. Cl. 709/206

(57) ABSTRACT

A method of communication via instant messaging that avoids some of the costs and disadvantages for doing so in the prior art. In particular, the illustrative embodiment enables instant messaging clients to function as an intercom, in which one user can cause audio signals, such as speech, to be output from a second user's instant messaging client without any action on the part of the second user. This is in direct contrast to a traditional telephone call in which the second user must take some action to “answer” the call before the first user's voice is heard. Such an instant messaging intercom capability will be especially useful for secretaries and others who collaborate on work.

### FIELD OF THE INVENTION

The present invention relates to telecommunications in general, and, more particularly, to instant messaging.

### BACKGROUND OF THE INVENTION

Instant messaging is form of real-time communication between two or more people based on typed text. The text is conveyed by data processing systems (e.g., computers, personal digital assistants, Blackberrys, etc.) over a network such as the Internet or an intranet.

Instant messaging offers real-time communication and allows easy collaboration, which might be considered more akin to genuine conversation than e-mail's store and forward/retrieve mechanism. In contrast to e-mail, the Instant Messaging parties know whether the peer is available via a Presence Service that is inherent in the Instant Messaging system. Most Instant Messaging systems allow the user to set an online status or away message so peers are notified when the user is available, busy, or away from the computer or do so automatically based on the user's activity level on their computer or activity within the Instant Messaging system itself. In most cases, the user is allowed to manually override the automated presence state. On the other hand, recipients of instant messages do not necessarily have to respond immediately to incoming messages. For this reason, users consider communication via instant messaging to be less intrusive than communication via telephone. However, some systems allow the sending of messages to people not currently logged on (offline messages), thus removing much of the difference between instant messaging and email.

### SUMMARY OF THE INVENTION

The present invention provides a method of communication via instant messaging that avoids some of the costs and disadvantages for doing so in the prior art. In particular, the illustrative embodiment enables instant messaging clients to function as an intercom, in which one user can cause audio signals, such as speech, to be output from a second user's instant messaging client without any action on the part of the second user. This is in direct contrast to a traditional telephone call in which the second user must take some action to “answer” the call before the first user's voice is heard. Such an instant messaging intercom capability will be especially useful for secretaries and others who collaborate on work.

The illustrative embodiment comprises: transmitting an electro-magnetic signal representing audio from a first instant messaging client on a first data processing system to a second instant messaging client on a second data processing system; and receiving the electro-magnetic signal at the second instant messaging client on the second data processing system; CHARACTERIZED BY: outputting an acoustic signal based on the electro-magnetic signal from the second data processing system without any action by a user of the second data processing system.

### BRIEF DESCRIPTION OF THE DRAWINGS

FIG. 1 depicts a block diagram of the salient components of the illustrative embodiment of the present invention.

FIG. 2 depicts a block diagram of the salient components of data processing system 102-i.

FIG. 3 depicts a flow chart of the salient tasks associated with the performance of the illustrative embodiment of the present invention.

### DETAILED DESCRIPTION

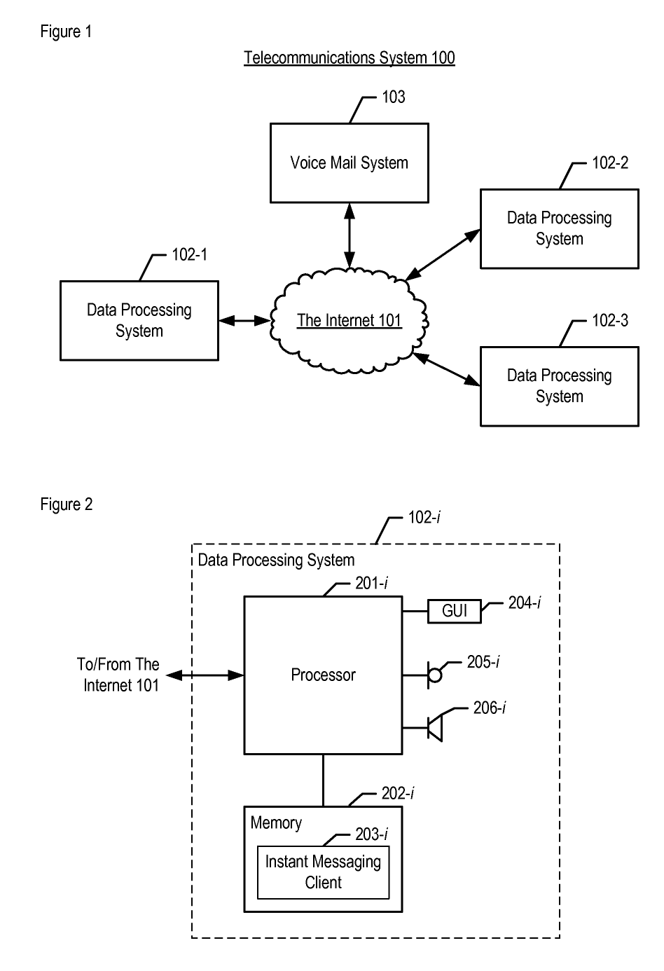

FIG. 1 depicts a block diagram of the salient components of the illustrative embodiment of the present invention. Telecommunications system 100 comprises: the Internet 101 and data processing systems 102-1 through 102-3, interconnected as shown.

Although the illustrative embodiment depicts three data processing systems, it will be clear to those skilled in the art, after reading this disclosure, how to make and use alternative embodiments of the present invention that use any number of data processing systems.

The Internet 101 is the ubiquitous packet network and it will be clear to those skilled in the art how to extend and use the Internet. Although the illustrative embodiment uses the Internet as the communications network through with the data processing systems communicate, it will be clear to those skilled in the art, after reading this disclosure, how to make and use alternative embodiments of the present invention that use any telecommunications network (e.g., the Public Switched Telephone Network, a wireless network, an IBM SNA network, etc.).

Data processing system 102-i, wherein i is a member of the set {1, 2, 3}, comprises hardware and software for performing the tasks described below and in the accompanying figures. In accordance with the illustrative embodiment, each of data processing systems 102-1, 102-2, and 102-3 are connected to the Internet 101 via a wireline connection, but it will be clear to those skilled in the art, after reading this disclosure, how to make and use alternative embodiments of the present invention in which any or all of the data processing systems are connected to the Internet 101 via a wireless connection.

In accordance with the illustrative embodiment, each of data processing systems 102-1, 102-2, and 102-3 are identical, but it will be clear to those skilled in the art, after reading this disclosure, how to make and use alternative embodiments of the present invention in which any or all of the data processing systems are not identical.

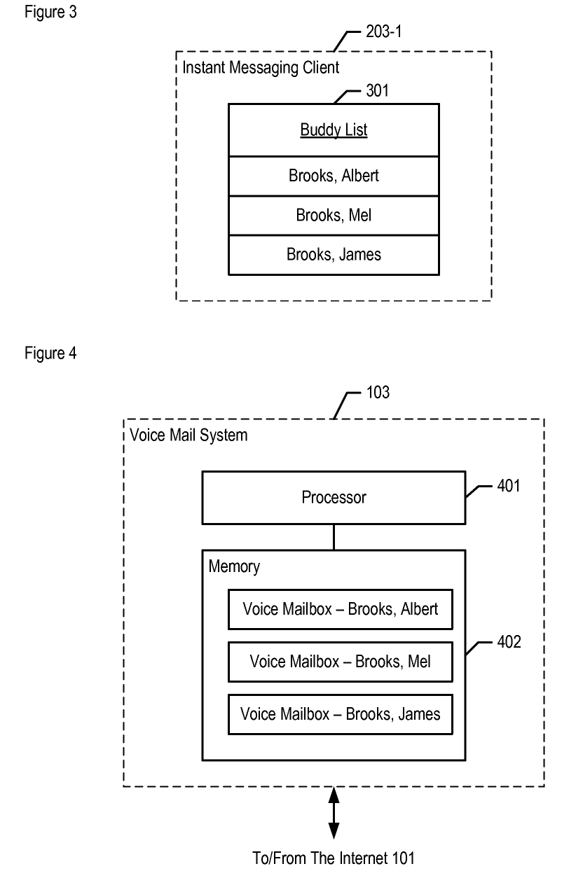

FIG. 2 depicts a block diagram of the salient components of data processing system 102-i, which comprises: processor 201-i, memory 202-i, instant messaging client 203-i, graphical user interface 204-i, microphone 205-i, and speaker 206-i, interconnected as shown.

Processor 201-i is hardware, as is well known in the prior art, for executing commands in memory 202-i, for storing into and retrieving data from memory 202-i, for transmitting packets to and receiving packets from the Internet, and for interfacing with graphical user interface 204-i, microphone 205-i, and speaker 206-i. It will be clear to those skilled in the art how to make and use processor 201-i.

Memory 202-i is a non-volatile storage, as is well known in the prior art, for storing programs and data, including instant messaging client 203-i. It will be clear to those skilled in the art how to make and use memory 202-i.

Instant messaging client 203-i is a program that transmits text and audio in accordance with the instant messaging protocol and in the manner described in detail below and in the accompanying figure.

Graphical user interface 204-i comprises a display, keyboard, and pointing device for enabling a user of data processing system 102-i to control data processing system 102-i in general and instant messaging client 203-i in particular. It will be clear to those skilled in the art how to make and use graphical user interface 204-i.

Microphone 205-i is an electro-acoustic transducer for converting an acoustic signal (e.g., speech, etc.) into an electro-magnetic representation of that acoustic signal. It will be clear to those skilled in the art how to make and use microphone 205-i.

Speaker 206-i is an electro-acoustic transducer for converting an electro-magnetic signal into an acoustic representation of that electro-magnetic signal. It will be clear to those skilled in the art how to make and use speaker 206-i.

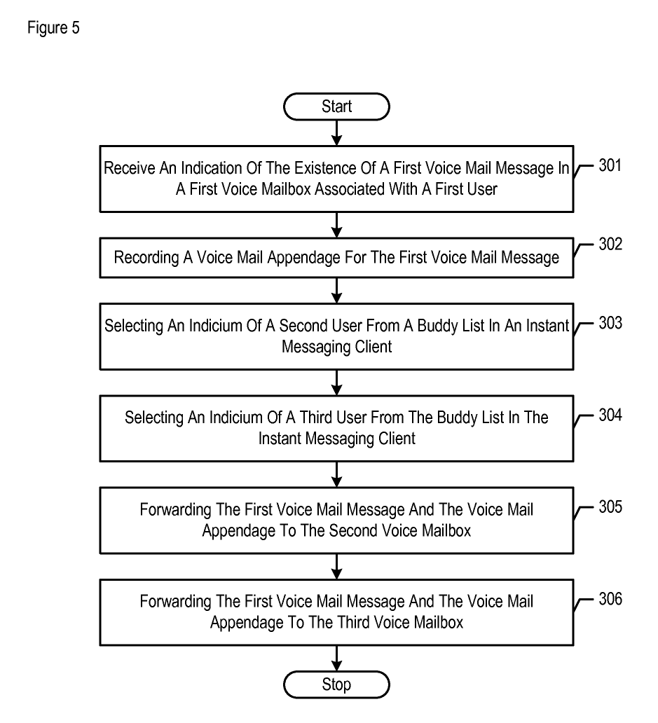

FIG. 3 depicts a flow chart of the salient tasks associated with the performance of the illustrative embodiment of the present invention.

At task 301, data processing system 102-1—running instant messaging client 203-1—receives an acoustic signal via microphone 205-1, which converts the acoustic signal into an electro-magnetic representation of the acoustic signal. As part of task 301, data processing system 102-1 and instant messaging client 203-1 also receive an instruction from a user of data processing system 102-1 to:
(1) transmit the electro-magnetic representation of the acoustic signal to data processing system 102-2 and output an acoustic representation of the electro-magnetic signal to a user of data processing system 102-2 without requiring any action on the part of the user of data processing system 102-2, and
(2) transmit the electro-magnetic representation of the acoustic signal to data processing system 102-3 and output an acoustic representation of the electro-magnetic signal to a user of data processing system 102-3 without requiring any action on the part of the user of data processing system 102-3.
   From task 301, control passes to task 302.

At task 302, data processing system 102-1 transmits:
(1) the electro-magnetic representation of the acoustic signal to data processing system 102-2 and an instruction to data processing system 102-2 to output the acoustic representation of the electro-magnetic signal without any action on the part of a user of data processing system 102-2, and
(2) the electro-magnetic representation of the acoustic signal to data processing system 102-2 and an instruction to data processing system 102-2 to output the acoustic representation of the electro-magnetic signal without any action on the part of a user of data processing system 102-2.
   In accordance with the illustrative embodiment, the electro-magnetic representation of the acoustic signal is transmitted in a voice-over-internet-protocol format, but it will be clear to those skilled in the art, after reading this disclosure, how to make and use alternative embodiments of the present invention. From task 302, control spawns both tasks 303 and 304, which run concurrently and independently.

At task 303, data processing system 102-2—running instant messaging client 203-2—receives the electro-magnetic signal from data processing system 102-1 and the instruction to output an acoustic representation of the electro-magnetic signal without any action on the part of a user of data processing system 102-2. From Task 303, control passes to task 305.

At task 304, data processing system 102-3—running instant messaging client 203-3—receives the electro-magnetic signal from data processing system 102-1 and the instruction to output an acoustic representation of the electro-magnetic signal without any action on the part of a user of data processing system 102-3. From Task 304, control passes to task 307.

At task 305, data processing system 102-2 determines if a user of instant messaging client 203-2 has set a “do not disturb” mode, which prevents instant messaging client 203-2 from outputting an acoustic representation of the electro-magnetic signal without any action on the part of a user of data processing system 102-2. If the do-not-disturb mode is set, data processing system 102-1 is informed that the user of instant messaging client 203-2 cannot be disturbed and control does not proceed to task 306; otherwise control proceeds to task 306.

At task 306, instant messaging client 203-2 directs data processing system 102-2 to output the acoustic representation of the electro-magnetic signal without any action by a user of data processing system 102-2.

At task 307, data processing system 102-3 determines if a user of instant messaging client 203-3 has set a “do not disturb” mode, which prevents instant messaging client 203-3 from outputting an acoustic representation of the electro-magnetic signal without any action on the part of a user of data processing system 102-3. If the do-not-disturb mode is set, data processing system 102-1 is informed that the user of instant messaging client 203-3 cannot be disturbed and control does not proceed to task 308; otherwise control proceeds to task 308.

At task 308, instant messaging client 203-3 directs data processing system 102-3 to output the acoustic representation of the electro-magnetic signal without any action by a user of data processing system 102-3.

It is to be understood that the disclosure teaches just one example of the illustrative embodiment and that many variations of the invention can easily be devised by those skilled in the art after reading this disclosure and that the scope of the present invention is to be determined by the following claims.

What is claimed is:

1. A method comprising:
transmitting an electro-magnetic signal representing audio from a first instant messaging client on a first data processing system to a second instant messaging client on a second data processing system; and
receiving the electro-magnetic signal at the second instant messaging client on the second data processing system;
CHARACTERIZED BY:
outputting an acoustic signal based on the electro-magnetic signal from the second data processing system without any action by a user of the second data processing system.

2. The method of claim 1 further comprising:
transmitting the electro-magnetic signal from the first instant messaging client to a third instant messaging client on a third data processing system; and
receiving the electro-magnetic signal at the third instant messaging client on the third data processing system;
CHARACTERIZED BY:
outputting the acoustic signal from the third data processing system without any action by a user of the third data processing system.

3. The method of claim 1 wherein the second instant messaging client comprises do-not-disturb mode that prevents the output of the acoustic signal from the second data processing system.

4. The method of claim 1 wherein the electro-magnetic signal is transmitted in accordance with a voice-over-internet-protocol protocol.

5. A method comprising:
transmitting an electro-magnetic signal representing audio from a first instant messaging client on a first data processing system to: (1) a second instant messaging client on a second data processing system, and (2) a third instant messaging client on a third data processing system;
receiving the electro-magnetic signal at the second instant messaging client on the second data processing system; and
receiving the electro-magnetic signal at the third instant messaging client on the third data processing system;
CHARACTERIZED BY:
outputting an acoustic signal based on the electro-magnetic signal from the second data processing system without any action by a user of the second data processing system;
outputting the acoustic signal from the third data processing system without any action by a user of the third data processing system.

6. The method of claim 5 wherein the second instant messaging client comprises a do-not-disturb mode that prevents the output of the acoustic signal from the second data processing system.

7. The method of claim 5 wherein the electro-magnetic signal is transmitted in accordance with a voice-over-internet-protocol protocol.
